(19) United States
(12) Patent Application Publication
(10) Pub. No.: US 2018/0358196 A1
(43) Pub. Date: Dec. 13, 2018

(54) CIRCUIT BREAKER COMPRISING A PASSIVELY HEATED BIMETAL ELEMENT ACTING ON A MAGNETIC YOKE OF AN ELECTROMAGNETIC TRIPPING DEVICE

(71) Applicant: Eaton Industries (Austria) GmbH, Schrems (AT)

(72) Inventor: Matthias Katzensteiner, Vienna (AT)

(21) Appl. No.: 15/527,715

(22) PCT Filed: Nov. 20, 2015
(86) PCT No.: PCT/EP2015/077264

§ 371 Date: Nov. 14, 2017

(30) Foreign Application Priority Data
Nov. 20, 2014 (DE) 10 2014 117 035.0

(51) Int. Cl. H01H 71/40; H01H 71/24

(52) U.S. Cl. CPC H01H 71/402; H01H 2071/407; H01H 71/2454; H01H 71/2463

(57) ABSTRACT

A circuit breaker has at least two terminal contacts which are electrically connected within the circuit breaker via a switching contact; an electromagnetic tripping device which acts on the switching contact and the coil of which is connected between the at least two terminal contacts; and a bimetal element acting on the switching contact, wherein, in the circuit breaker, the electrical connection between the at least two terminal contacts bypasses the bimetal element, and the bimetal element is thermally coupled to the electromagnetic tripping device, and the bimetal element indirectly acts on the switching contact via an iron circuit or magnetic yoke of the electromagnetic tripping device.

### CROSS-REFERENCE TO RELATED APPLICATIONS

This application is a U.S. national stage application under 35 U.S.C. § 371 of International Application No. PCT/EP2015/077264, filed on Nov. 20, 2015, and claims benefit to German Patent Application No. DE 10 2014 117 035.0, filed on Nov. 20, 2014. The International Application was published in German on May 26, 2016, as WO 2016/079318 A1 under PCT Article 21(2).

### FIELD

The invention relates to a circuit breaker comprising at least two terminal contacts that are electrically connected within the circuit breaker via a switching contact.

### BACKGROUND

Circuit breakers are for protecting a line from an excessive application of current. If a predetermined threshold is exceeded, the switching contact between the terminal contacts is opened and the circuit is thus interrupted. The tripping in conventional circuit breakers may generally take place electromagnetically, using a bimetal element, manually, and in many cases also by way of an external terminal.

Electromagnetic tripping primarily aims to break the circuit in the event of high overcurrent. Because current is flowing through the coil of the electromagnetic tripping device of the circuit breaker, and also flows via the terminal contacts, the force generated by the electromagnetic tripping device is dependent on the current intensity. Above a particular threshold, the switching contact is opened by this force. The electromagnetic tripping device responds very rapidly, meaning that the delay time between an overcurrent occurring and the switching contact opening is only very short.

Tripping by way of the bimetal element (generally in strip form) takes place much more slowly, and is primarily intended to prevent excessively long-enduring current that is only slightly above a set threshold. For this purpose, the bimetal element is connected into the electrical connection between the terminal contacts of the circuit breaker and is thus flowed through by the current flowing via the terminal contacts. Thus, the bimetal element is gradually heated in accordance with the electrical resistance thereof, and switches off after a delay time, which is dependent on the intensity of the current. Thus, a high overcurrent leads to an earlier switch-off and a lower current leads to a later switch-off.

Generally, the electromagnetic tripping device or bimetal element may act on the switching contact directly or indirectly. In the latter case, the electromagnetic tripping device/bimetal element may in particular act on a lever system connected to the switching contact.

A drawback of known circuit breakers is that the sometimes very high currents flowing via the terminal contacts of the circuit breaker are applied to the bimetal element. Further, the construction of a circuit breaker switch is complex as a result of the many individual parts. Finally, the current flowing via the bimetal element, which current also acts as an ohmic resistance, causes a considerable power loss and thus leads to poor efficiency of the circuit breaker.

### SUMMARY

An aspect of the invention provides a circuit breaker, comprising: a first terminal contact and a second terminal contact, the first and second terminal contacts being electrically connected within the circuit breaker via a switching contact; an electromagnetic tripping device configured to act on the switching contact or on a lever system connected to the switching contact, a coil of the electromagnetic tripping device being connected between the first and second terminal contacts; a bimetal element configured to act on the switching contact or on the lever system, wherein an electrical connection between the first and second terminal contacts bypasses the bimetal element, wherein the bimetal element is thermally coupled to the electromagnetic tripping device, wherein the bimetal element is configured to act on the switching contact indirectly via an iron circuit or magnetic yoke of the electromagnetic tripping device, and wherein the bimetal element is inserted into the iron circuit or magnetic yoke of the electromagnetic tripping device such that a magnetic flux through the iron circuit/magnetic yoke in a first position of the bimetal element at a first temperature is less than the magnetic flux through the iron circuit/magnetic yoke in a second position of the bimetal element at a second temperature.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 a first example of a tripping mechanism of a circuit breaker;

FIG. 2 a second example of a tripping mechanism of a circuit breaker having a larger cross section of a coil wire;

FIG. 3 an example of a tripping mechanism in which a bimetal element acts on a plunger of an electromagnetic tripping device indirectly via a leaf spring;

FIG. 4 the arrangement of FIG. 3 in a tripped state;

FIG. 5 a further example of a tripping mechanism in which a bimetal element acts on a plunger of an electromagnetic tripping device via a leaf spring;

FIG. 6 a plan view of an example leaf spring;

FIG. 7 is a plan view of an example bimetal element; and

FIG. 8 an example of a tripping mechanism in which a bimetal element affects the iron circuit or magnetic yoke of an electromagnetic tripping device.

### DETAILED DESCRIPTION

An aspect of the invention relates to a circuit breaker comprising at least two terminal contacts that are electrically connected within the circuit breaker via a switching contact, an electromagnetic tripping device that acts on the switching contact and the coil of which is connected between the at least two terminal contacts, and a bimetal actuator acting on the switching contact or a bimetal element acting on the switching contact.

An aspect of the invention provides an improved circuit breaker. In particular, a current applied to the bimetal element should be reduced or eliminated and/or the power loss occurring in the circuit breaker should be reduced and/or the construction of a circuit breaker should be simplified.

An aspect of the invention provides a circuit breaker of the aforementioned type in which
the electrical connection between the at least two terminal contacts bypasses the bimetal element, and the bimetal element is thermally coupled to the electromagnetic tripping device
the bimetal element acts on the switching contact indirectly via an iron circuit or magnetic yoke of the electromagnetic tripping device.

In this way, the bimetal element is heated passively, in other words merely by the lost heat of the electromagnetic tripping device. As a result, the power loss occurring in the circuit breaker can also be reduced. Further, the thermal and electromagnetic short-circuit tripping devices are physically and functionally combined, in other words they may form an assembly. This simplifies the construction of a circuit breaker.

As a result, the disclosed arrangement is particularly suited for use in existing systems. The switching contact or lever system does not actually need to be changed for this purpose, since the bimetal element acts on the switching contact/lever system indirectly via the iron circuit or magnetic yoke of the electromagnetic tripping device. The use of a tripping mechanism of this type does not alter anything as regards the switching contact/lever system.

Generally, the aim is for the thermal tripping device of a circuit breaker (in other words for the bimetal element) to be largely independent of the ambient temperature. Therefore, the operating temperature, in other words the temperature at which the curvature of the bimetal element is sufficient for the switching contact to be opened, is selected to be comparatively high (for example over 100° C.). Further, the bimetal element should have sufficient operating capacity to trip the tripping mechanism of the circuit breaker. In other words, the product of distance and force at the free end of the bimetal element should be sufficiently high. For this purpose, a sufficient distance between the operating temperature and the reference temperature (for example 20° C.) is required.

In the overload range, a temperature sufficient as an operating temperature for the bimetal generally occurs in the coil of a magnetic tripping device of a circuit breaker. Further, the heating performance of said electromagnetic tripping device is in most cases sufficient to heat the bimetal element and to ensure reliable tripping of the circuit breaker by the bimetal element.

Further, the following situation is advantageous for the stated operating principle: coils for high nominal currents have a low winding number along with a large conductor cross section, whilst coils for low nominal currents have a comparatively high winding number along with a low conductor cross section. As a result, magnetic forces of substantially the same order of magnitude are achieved over a large nominal current range. Accordingly, the power converted into heat is also of the same order of magnitude.

Further advantageous embodiments and developments of the invention may be derived from the dependent claims and from the description viewed in conjunction with the drawings.

However, it is also favorable if the bimetal element is arranged spaced apart from the electromagnetic tripping device, in particular from the coil. As a result, good electrical insulation can be achieved between the electromagnetic tripping device, in particular the coil thereof, and the bimetal element. Short-circuiting of the coil by the bimetal element is also prevented even if the insulation of the coil should be defective for any reason.

In a preferred variant of the circuit breaker, the bimetal element and the electromagnetic tripping device, in particular the coil thereof, are arranged directly adjacent in the circuit breaker. In this way, the bimetal element can be heated well by thermal radiation. In this context, “directly adjacent” means that there is no significant shielding from other components in the zone relevant for heat transfer by radiation between the electromagnetic tripping device, in particular the coil thereof, and the bimetal element. Preferably, at least 90% of the rays emitted by the electromagnetic tripping device, in particular the coil thereof, in this zone should reach the bimetal element unimpeded. This means 90% of the rays that proceed from the electromagnetic tripping device and that can in principle reach the bimetal element given the physical positions of the electromagnetic tripping device and the bimetal element.

It is particularly advantageous if the bimetal element is provided, at least in the region of the thermal coupling to the electromagnetic tripping device, and/or the electromagnetic tripping device is provided, at least in the region of the thermal coupling to the bimetal element, with a coating that absorbs at least 90% of the infrared radiation. In this way, the heat transfer from the electromagnetic tripping device reaches the bimetal element particularly well. The bimetal element and/or electromagnetic tripping device may be coated accordingly for this purpose. For good thermal transfer, in this context it is the absorption capacity in the infrared region that is relevant; in the visible wavelength range, it is perfectly possible for said elements to be of a color other than black.

It is favorable if the bimetal element is arranged above the electromagnetic tripping device, in particular above the coil, or a conduction device for conducting hot air from the electromagnetic tripping device to the bimetal element is provided. In this way, the bimetal element can be heated well by convection. Hot air rising from the electromagnetic tripping device thus spreads around the bimetal element and heats it. In this context, it is particularly advantageous if a turbulent current is generated, in particular by the shape of the electromagnetic tripping device, the coil thereof or the conduction device.

In a particularly preferred embodiment of the circuit breaker, the bimetal element forms at least part of a yoke of the electromagnetic tripping device. On the one hand, the bimetal element may in turn be heated by eddy currents; on the other hand, it forms part of the magnetic yoke of the electromagnetic tripping device, resulting in a particularly strong synergistic effect. This variant of the invention operates particularly well if the bimetal element has a comparatively high iron content. Generally, at a frequency of 50 Hz, eddy currents only contribute a comparatively small proportion of the heating of the bimetal element.

In a production series of a plurality of circuit breakers, it is further advantageous if the coils are made of wire of different thicknesses and have substantially the same diameter, in particular external diameter. As a result, a production series of circuit breakers having relatively few constructional forms of the components thereof can be constructed, since all coils have the same diameter (preferably the same external diameter), and the components of the circuit breaker fit together without major adaptations. Ideally, no different constructional forms of the components of the circuit breaker need be provided at all. In an advantageous variant, the coil wires of different thicknesses are additionally wound on coil sleeves of different diameters, resulting in coils of substantially the same external diameter within the production series of circuit breakers.

Finally, in a production series of a plurality of circuit breakers, it is favorable if the distance between the bimetal element and the electromagnetic tripping device, in particular the coil thereof, is substantially the same in a plurality of circuit breakers. This provides that the heat transfer from the electromagnetic tripping device to the bimetal element is substantially the same within a production series of circuit breakers having coil wire of different thicknesses.

An advantageous construction of the circuit breaker is further provided if the bimetal element acts on the switching contact or a lever system connected thereto directly or indirectly at the armature/plunger of the electromagnetic tripping device. As a result, it is possible to have an even stronger effect on the electromagnetic tripping device.

In this context, it is advantageous if the circuit breaker comprises a leaf spring that is arranged transverse to the movement direction of the armature/plunger, acts on the armature/plunger, and is mounted fixed with respect to the electromagnetic tripping device at one end and connected to the bimetal element at the other end, in particular mounted and/or connected in an articulated manner.

It is favorable if the leaf spring acts on the end of the armature/plunger facing away from the switching contact or lever system. As a result, the interface between the armature/plunger and the switching contact or lever system can be kept simple. Further, an arrangement of this type can also be used for existing systems, since said interface does not need to be changed for this purpose.

It is additionally favorable if the leaf spring is merely placed on the armature/plunger. This results in a simple construction of the circuit breaker.

It is further favorable if the leaf spring is connected/hooked to the armature/plunger. As a result, both tensile and compressive forces can be transmitted between the leaf spring and the armature/plunger.

It is advantageous if the leaf spring/bimetal element has forked ends in which a groove in the bimetal element/leaf spring engages. As a result, a rotary joint between the leaf spring and the plunger can be implemented in a simple manner.

If is further advantageous if the lead spring/plunger has a recess in which a groove in the plunger/leaf spring engages. As a result, a rotary joint between the leaf spring and the plunger can be implemented in a simple manner.

It is advantageous if the bimetal element curves away from the electromagnetic tripping device during heating. In combination with a leaf spring, this results in a decreasing progression of the force acting on the plunger. Likewise, in this context there is an increasing progression of the distance covered by the plunger with respect to the distance covered by the free end of the bimetal element.

However, it is also advantageous if the bimetal element bends towards the electromagnetic tripping device during heating. As a result, the bimetal element can press directly on the plunger of the electromagnetic tripping device. In combination with a leaf spring, this further results in an increasing progression of the force acting on the plunger. Likewise, in this context there is a decreasing progression of the distance covered by the plunger with respect to the distance covered by the free end of the bimetal element.

It is favorable if a compression spring, the force of which is directed away from the switching contact or lever system, acts on the armature/plunger. As a result, the armature/plunger is pulled away from the switching contact or lever system independently of the leaf spring. This variant is advantageous in particular if the leaf spring is merely positioned on the armature/plunger and not connected/hooked thereto.

It is also particularly advantageous if the bimetal element acts on the switching contact indirectly via the iron circuit or magnetic yoke of the electromagnetic tripping device. As a result, reactions on the bimetal element, such as may occur if the bimetal element acts on the plunger of the electromagnetic tripping device, can be prevented or at least reduced.

In this context, it is advantageous if the at least one bimetal element is inserted into the iron circuit or magnetic yoke of the electromagnetic tripping device in such a way that a magnetic flux through the iron circuit/magnetic yoke in a first position of the at least one bimetal element at a first temperature is less than the magnetic flux through the iron circuit/magnetic yoke in a second position of the at least one bimetal element at a second temperature. Advantageously, in this way the magnetic flux in the iron circuit or magnetic yoke and thus the generated electromagnetic force on the plunger of the electromagnetic tripping device can be influenced. The bimetal element thus takes effect on the switching contact indirectly via the electromagnetic tripping device. Advantageously, the force that the bimetal element has to apply is very small, since it basically works as a switch. The bimetal element can therefore be kept very small.

In this context, it is favorable if the first temperature is less than the second temperature. As a result, the magnetic flux and thus the force acting on a plunger of the electromagnetic tripping device are greater at the higher temperature. An increase in current therefore always brings about an increase in said force, regardless of whether this takes place by way of the current through the coil of the electromagnetic tripping device or by way of the bimetal element changing from the first to the second position as a result of the increased current.

It is particularly advantageous if the circuit breaker comprises a gap in the iron circuit/magnetic yoke that is variable as a function of the temperature of the at least one bimetal element. As a result, the magnetic flux in the iron circuit/magnetic yoke can be affected relatively strongly, since the magnetic resistance formed by the gap is a linear function of the size of the gap.

It is further favorable if exactly one gap per bimetal element in the iron circuit/magnetic core is variable as a function of the temperature of said bimetal element. This results in a comparatively simple construction of the electromagnetic tripping device, since one end of the bimetal element can be connected fixedly to the iron circuit/magnetic yoke.

However, it is also favorable if exactly two gaps in the iron circuit/magnetic yoke per bimetal element are variable as a function of the temperature of said bimetal element. In this way, the effect of the bimetal element can be amplified.

It is advantageous if a gap that is present at the first temperature is closed at the second temperature. In this way, the effect of the bimetal element on the iron circuit/magnetic yoke of the electromagnetic tripping device is particularly strong.

It is favorable if exactly one bimetal element is inserted into the iron circuit/magnetic yoke. This results in a comparatively simple construction of the electromagnetic tripping device.

However, it is also favorable if exactly two bimetal elements are inserted into the iron circuit/magnetic yoke. In an embodiment of this type, an emergency function of the electromagnetic tripping device can be maintained even if a bimetal element should fail for any reason.

It is further advantageous if the at least one bimetal element is arranged parallel to a movement direction of a plunger of the electromagnetic tripping device. This results in a particularly compact construction of the circuit breaker.

Finally, it is favorable if the circuit breaker comprises a plastics material tube arranged between an inner limb of the iron circuit/magnetic yoke and the coil of the electromagnetic tripping device. If the plastics material is selected appropriately, the friction between the plastics material pipe and the inner limb, which may in particular also be mounted displaceable in the plastics material pipe, can be kept low. In addition, the magnetic flux is also concentrated on said inner limb.

The above embodiments and developments of the invention can be combined in any desired manner.

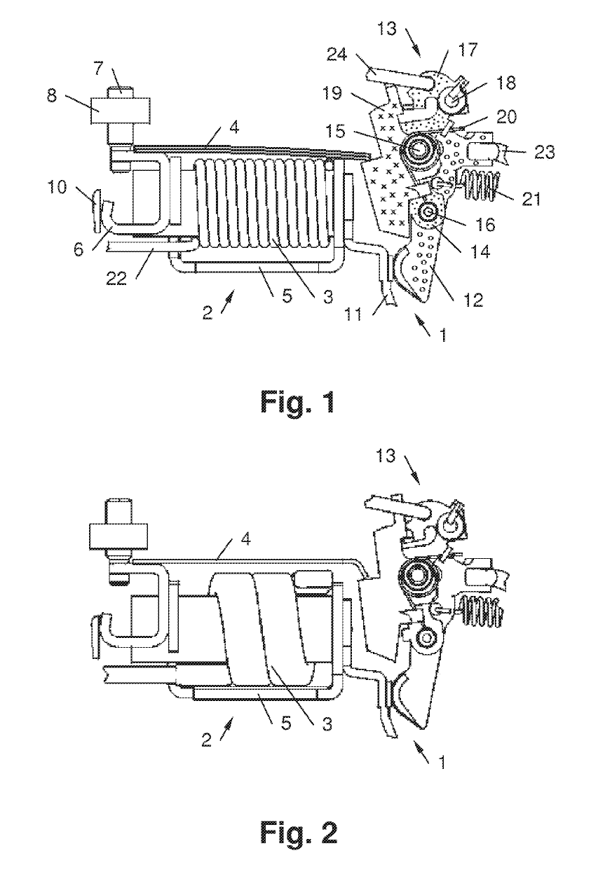

FIG. 1 shows a first example of a tripping mechanism of a circuit breaker. Generally, a circuit breaker comprises at least two terminal contacts that are electrically connected within the circuit breaker via a switching contact 1. The circuit breaker or the tripping mechanism thereof further comprises an electromagnetic tripping device 2 that acts on the switching contact 1 and the coil 3 of which is connected between the at least two terminal contacts and a bimetal element 4 acting on the switching contact 1.

Specifically, as well as the coil 3, the electromagnetic tripping device 2 also comprises a yoke 5 and an armature or plunger (not visible in FIG. 1 as a result of being retracted). The bimetal element 4 is fixed to a bimetal support 6 and can be adjusted in position (vertically in FIG. 1) using a screw 7 that is guided through a nut 8 fixed with respect to the housing. The bimetal support 6 is braced on the housing 10 of the circuit breaker 1, and is thus secured against rotation.

In this way, the switch point or trip point of the bimetal element 4 can be adjusted. Further, the distance of the bimetal element 4 from the electromagnetic tripping device 2 can be adapted to coils 3 of different sizes. As a result, even though differently sized wire cross sections of the coils 3 are required for different current intensities and the coils 3 may also have otherwise different dimensions, circuit breakers for different currents may be of substantially the same construction.

The switching contact 1 comprises a stationary fixed contact 11 and a movable contact piece 12, which is simultaneously part of the lever system 13. For improved clarity, the contact piece 12 is shown using small rings so as to be better able to explain the operation of the lever system 13 in the following. The lever system 13 further comprises a contact piece support 14, which is mounted rotatable about a shaft 15 fixed with respect to the housing and is marked using dots. The contact piece 12 is mounted rotatable about the shaft 16 arranged on the contact piece support 14. The lever system 13 further comprises a latch 17, which is mounted rotatable about a shaft 18 arranged on the contact piece support 15 and is likewise marked using dots. Further, the lever system 13 comprises a latch bearing 19, which is mounted rotatable about the shaft 15 and is marked using small crosses. Finally, the lever system 13 comprises a torsion spring 20, which presses the latch 17 and the latch bearing 19 together, and a tension spring 21, the force of which acts on the contact piece 12.

Finally, FIG. 1 further shows connection wires 22 and 23, which connect the electromagnetic tripping device 2 or contact piece 12 to the outwardly guided terminal contacts of the circuit breaker. By contrast, the electrical connection between the at least two terminal contacts bypasses the bimetal element 4. Finally, FIG. 1 further shows a bracket 24 which connects the latch 17 to a switching lever of the circuit breaker.

The operation of the tripping mechanism shown in FIG. 1 is now as follows:

In an ON position, the bimetal element 4 is straight, in such a way that the torsion spring 20 presses the latch bearing 19 onto the latch 17 and the protrusion of the latch 17 hooks into the latch bearing 19. As a result, the contact piece support 14, the latch 17 and the latch bearing 19 are now moved together, in other words rotated about the shaft 15 fixed with respect to the housing. The spring 21 pulls the contact piece 12 clockwise about the shaft 16, causing the switching contact 1 to remain closed in the ON position. If the switching lever of the circuit breaker is now moved into the OFF position, the bracket 24 pulls the contact piece support 14, the latch 17 and the latch bearing 19, which are hooked into one another, counterclockwise and thus causes the shaft 16 to be moved to the right, opening the switching contact 1 as a result.

As a further option, the circuit breaker may be tripped by the electromagnetic tripping device 2. If the current is too high, the armature presses on the latch bearing 19, in such a way that the latching between the latch 17 and the latch bearing 19 is released. The latch bearing 19 and the latch 17 are thus located in the position shown in FIG. 1. As a result of the tensile spring 21, the contact piece support 14 is now rotated about the shaft 15 counterclockwise, the latch 17 being deflected upwards and thus completing a clockwise rotation. As a result, the shaft 16 arranged on the contact piece support 14 migrates to the right, opening the switching contact 1.

The circuit breaker is tripped using the bimetal element 4 in a similar manner. During strong heating, said element presses on a projection of the latch bearing 19, causing this in turn to rotate about the shaft 15 counterclockwise and thus releasing the locking between the latch 17 and the latch bearing 19. This situation is shown in FIG. 1. The further movement sequence is entirely analogous to that carried out for tripping by the electromagnetic tripping device.

The tripping by the electromagnetic tripping device 2 and by the bimetal element 4 is thus substantially functionally equivalent. Only the action points, the directions and optionally the size of the forces applied to the latch bearing 19 by the electromagnetic tripping device 2 or the bimetal element 4 are different. In both cases, however, rotation of the latch bearing 19 counterclockwise about the shaft 15 is brought about.

As a result of the bimetal element 4 being arranged in the direct vicinity of the electromagnetic tripping device 2, the bimetal element 4 is heated by the lost heat of the electromagnetic tripping device 2. The electromagnetic tripping device 2, the primary function of which is to detect short-circuit currents and the opening of the switching contact 1 in the event of overcurrent, thus simultaneously acts as a heating winding. This results in a dual use of the electromagnetic tripping device 2.

The tripping mechanism shown in FIG. 1 of the circuit breaker also has the following further features.

In the present example, the bimetal element 4 is arranged at a distance from the electromagnetic tripping device 2, in particular at a distance from the coil 3. As a result, good electrical insulation can be achieved between the electromagnetic tripping device 2, in particular the coil 3 thereof, and the bimetal element 4. Short-circuiting of the coil by the bimetal element 4 is thus prevented even if the insulation of the coil should be defective for any reason. However, the closer to the electromagnetic tripping device 2 the bimetal element 4 is arranged, the better the heat transfer from the electromagnetic tripping device 2 to the bimetal element 4.

Further, the bimetal element 4 and the electromagnetic tripping device 2, in particular the coil 3 thereof, are arranged directly adjacent in the circuit breaker. In this way, the bimetal element 4 can be heated well by thermal radiation, since no significant shielding due to other components occurs in the zone relevant for heat transfer by radiation between the electromagnetic tripping device 2, in particular the coil 3 thereof, and the bimetal element 4. Preferably, at least 90% of the radiation emitted in the relevant transfer zone by the electromagnetic tripping device 2, in particular the coil 3 thereof, reaches the bimetal element 4. In this context, it is advantageous if the bimetal element 4 is oriented in such a way that the heat transfer takes place on as large an area as possible.

It is also advantageous in this context if the bimetal element 4 is provided, at least in the region of the thermal coupling to the electromagnetic tripping device 2, and/or the electromagnetic tripping device 2 is provided, at least in the region of the thermal coupling to the bimetal element 4, with a coating that absorbs at least 90% of the infrared radiation. In this way, the heat transfer by radiation from the electromagnetic tripping device 2 reaches the bimetal element 4 particularly well.

It is further advantageous if the bimetal element 4 is arranged above the electromagnetic tripping device 2, in particular above the coil 3, as is shown in FIG. 1. In this way, the bimetal element 4 is heated not only by radiation but also by convection in the form of warm air that rises from the electromagnetic tripping device 2 and spreads around the bimetal element 4. Alternatively or additionally a conduction device for conducting hot air from the electromagnetic tripping device 2 to the bimetal element 4 may be provided.

Although the variant shown in FIG. 1 of the tripping mechanism of a circuit breaker is advantageous, other embodiments are also conceivable. Generally, it is possible to provide an intermediate element or intermediate layer (for example Teflon, glass silk) between the bimetal element 4 and the electromagnetic tripping device 2. For example, the bimetal element 4 may also contact the electromagnetic tripping device 2, in particular the coil 3 thereof, causing the bimetal element 4 to be heated well by thermal conduction.

It is also advantageous if the bimetal element 4 forms at least part of the yoke 5 of the electromagnetic tripping device 2. For example, for this purpose, the yoke 5 may bypass the coil 3 from above. As a result, the bimetal element 4 is heated by eddy currents and also forms part of the yoke 5 of the electromagnetic tripping device 2, resulting in a particularly strong synergistic effect. This variant of the invention operates particularly well if the bimetal element 4 has a comparatively high iron content. A layer of the bimetal element 4 often already consists of magnetic steel in any case, and can thus simultaneously act as part of the magnetic yoke or yoke 5 of the electromagnetic tripping device 2. In this variant, the magnetic force on the bimetal element 4 should be taken into account in relation to short circuit currents, and it should also be taken into account that, at a frequency of 50 Hz, eddy currents only contribute a comparatively small proportion of the heating of the bimetal element 4.

FIG. 2 now shows a variant of a tripping mechanism of a circuit breaker which is very similar to the variant shown in FIG. 1. However, a difference is that the coil 3 of the electromagnetic tripping device 2 has a much larger cross section than the coil 3 shown in FIG. 1 and is therefore suitable for a much higher rated current. In addition, the bimetal element 4 is elbowed down in the front region. However, the mode of operation of the tripping mechanism shown in FIG. 2 is the same as for the tripping mechanism shown in FIG. 1.

It is advantageous if the coils 3 of a plurality of different circuit breakers of a production series of circuit breakers have substantially the same diameter (in this case internal diameter) as shown in FIGS. 1 and 2. As a result, a production series of circuit breakers having relatively few different constructional forms of the components thereof can be constructed. Ideally, no different constructional forms of the components of the circuit breaker need be provided at all.

In a plurality of different circuit breakers in a production series of circuit breakers, it is additionally advantageous if the distance between the bimetal elements 4 and the electromagnetic tripping devices 2, in particular the coils 3 thereof, is substantially the same as shown in FIGS. 1 and 2. As a result, the heat transfer from the electromagnetic tripping device 2 to the bimetal element 4 is substantially the same within a production series of circuit breakers having coil wire of different thicknesses.

In the production series of different circuit breakers shown in FIGS. 1 and 2, the coils 3 have substantially the same internal diameter. However, this is in no way compulsory. For example, it would also be conceivable for the coils 3 all to have substantially the same external diameter. As a result, the heat transfer from the electromagnetic tripping device 2 to the bimetal element 4 is substantially the same within a production series of circuit breakers having coil wire of different thicknesses, even without the distance of the bimetal element 4 being adapted using the screw 7. To achieve this, the coil wires of different thickness can be wound on coil sleeves of different diameters, resulting in coils 3 having substantially the same external diameter within the production series of circuit breakers.

A further option for adapting the tripping mechanism to coils 3 of different sizes is also provided in that a replaceable transmission piece may be provided, via which the bimetal element 4 acts on the latch bearing 19. Alternatively, an elbow of a different length (compare FIG. 2) may be provided for this purpose.

In the embodiments shown, the bimetal element 4 curves towards the coil 3 during heating. However, the tripping mechanism may also be constructed in such a way that the bimetal element curves away from the coil 3 during heating. For example, the bimetal element 4 in FIGS. 1 and 2 could be arranged below the coil 3 and for example act on a projection of the latch bearing 19. Advantageously, in the (unheated) initial position thereof the bimetal element 4 is very close to the coil 3. If the bimetal element 4 curves downwards during heating, the latch bearing 19 is moved counterclockwise, tripping the tripping mechanism in the manner disclosed previously above.

The bimetal element 4 may, as shown in FIGS. 1 and 2, actively apply a thermoelastically induced force for unlatching a tripping mechanism. Alternatively, however, it would also be possible for the bimetal element 4 to be biased and to hold the tripping mechanism in the ON state. If this force recedes when the bimetal element 4 is heated, the tripping mechanism is tripped, in other words the switching contact 1 is separated.

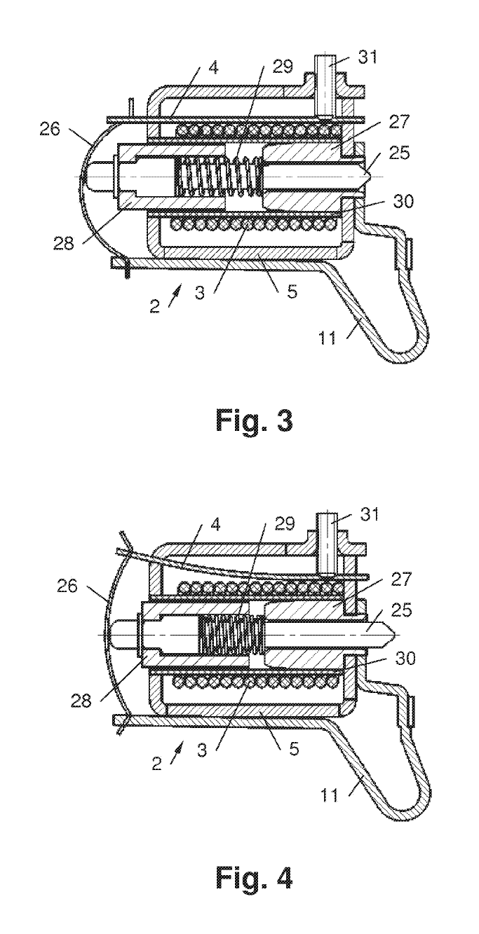

FIGS. 3 and 4 now show an embodiment of a tripping mechanism of a circuit breaker in which the bimetal element 4 acts on the switching contact 1 or on a lever system connected to the switching contact indirectly via the electromagnetic tripping device 2. FIGS. 3 and 4 only show the electromagnetic tripping device 2, including the bimetal element 4 acting thereon, and the fixed contact 11. However, the lever system comprising the contact piece, which may be configured in the same way as that shown in FIGS. 1 and 2, is not shown.

Specifically, the electromagnetic tripping device 2 comprises a movably mounted armature 25 or plunger, on which the bimetal element 4 acts indirectly via a leaf spring 26 arranged transverse to the movement direction of the armature/plunger 25. The leaf spring 26 is mounted fixed with respect to the electromagnetic tripping device 2 at one end and connected to the bimetal element 4 at the other end. In particular, the leaf spring 26 is mounted at one end via a fixed rotary joint and articulated to the bimetal element 4 at the other end.

The electromagnetic tripping device 2 further comprises a first and second sleeve 27 and 28 of the magnet circuit, which are in particular made of ferromagnetic material. The armature/plunger 25, preferably made of plastics material, is mounted displaceable in the first sleeve 27 and is pulled in the direction of the leaf spring 26 by means of a compression spring 29 and thus away from the lever system independently of the leaf spring 26. The armature/plunger 25 is further mounted in the second sleeve 28, which is in turn mounted displaceable in the sleeve 30, which is preferably made of plastics material. The electromagnetic tripping device 2 further comprises a fixing screw 31 for fixing the bimetal element 4.

The operation of the tripping mechanism shown in FIGS. 3 and 4 is now as follows, the tripping mechanism being shown in a rest state in FIG. 3 and in the tripped state in FIG. 4.

In the state shown in FIG. 3, the current guided via the circuit breaker is within the admissible range, in such a way that the armature/plunger 25 is retracted by the compression spring 29. If the current guided via the circuit breaker and thus via the coil 3 now rises, the two sleeves 27 and 28 are attracted by the electromagnetic force, and the bimetal element 4 is also heated and curves visibly outwards. If the current rises above the trip value (in a short time), the two sleeves 27 and 28 are pulled together counter to the force of the compression spring 29 by the electromagnetic force sufficiently hard that the armature/plunger 25 trips the lever system (not shown) and the switching contact is thus separated. The fact that the gap between the two sleeves 27 and 28 becomes narrower and narrower, and thus the magnetic flux or electromagnetic force becomes greater and greater, has an assisting effect in this context.

However, the current through the coil 3 also leads to heating of the bimetal element 4, which curves outwards counter to the force of the leaf spring 26 and counter to the force of the compression spring 29. As a result, the leaf spring 26 is pulled into a more or less elongate shape, and thus presses the armature/plunger 25 towards the lever system. In this case too, the gap becoming narrower and narrower between the two sleeves 27 and 28 leads to an increase in the electromagnetic force.

The tripping of the circuit breaker is thus dependent both on the temperature of the bimetal element 4 and on the present current through the coil 3. The temperature of the bimetal element 4 is in effect an integral of the current through the coil 3 with respect to time, meaning that the effect of the bimetal element 4 is predominant at currents which are above an admissible value for a long duration but only by a slight amount. However, if the current rises very rapidly a long way above an admissible value, the effect of the electromagnetic force on the armature/plunger 25 is predominant.

Generally, the arrangement shown in FIGS. 3 and 4 further has the following features. In this example, the leaf spring 26 acts on the end of the armature/plunger 25 facing away from the switching contact 1 or lever system 13. As a result, the interface between the armature/plunger 25 and the switching contact 1 or lever system 13 can be kept simple. Further, an arrangement of this type may also be used for existing systems, since said interface does not have to be adapted for this purpose.

Further, the leaf spring 16 is merely placed on the armature/plunger 25, resulting in a simple construction of the circuit breaker. Advantageously, the leaf spring 26 may also have forked ends in which a groove in the bimetal element 4 engages (compare also FIGS. 6 and 7). As a result, a rotary joint between the lead spring 26 and the bimetal element 4 can be implemented in a simple manner. For the same purpose, it is naturally also conceivable for the bimetal element 4 to have fork-shaped ends in which a groove in the leaf spring 26 engages.

In this example, the bimetal element 4 curves towards the electromagnetic tripping device 2 during heating. In combination with a leaf spring 26, this results in an increasing progression of the force acting on the plunger 25. Likewise, in this context there is a decreasing progression of the distance covered by the plunger 25 with respect to the distance covered by the free end (or the end acting on the leaf spring 26) of the bimetal element 4.

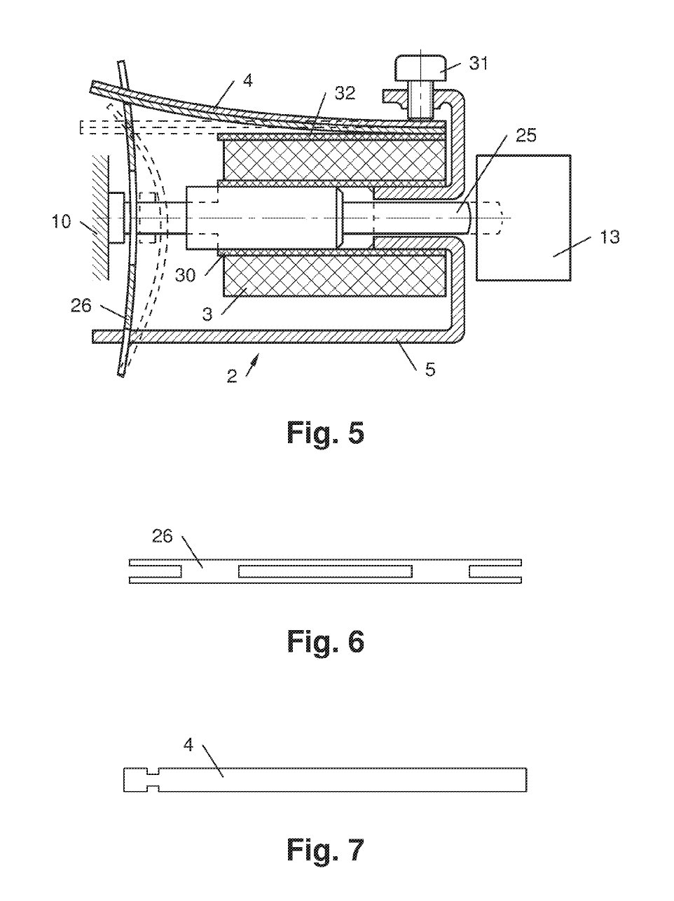

FIG. 5 now shows an embodiment similar to the embodiment shown in FIGS. 3 and 4. Now, however, the bimetal element 4 bends upwards in the initial state (shown in solid lines) and curves downwards during heating (shown in dashed lines). As a result, when the bimetal element 4 is heated, the leaf spring 26 is curved forwards and pushes the armature/plunger 25 in the direction of the lever system 13 which is merely schematically shown. In this example, the armature/plunger 25 is pulled away from the lever system 13 by the leaf spring 26 alone at a low current, until the armature/plunger 25 is positioned on a housing wall 10. A further compression spring is not provided, but the use thereof is not excluded. The armature/plunger 25 is mounted in the yoke 5 in the front region and in the plastics material sleeve 30 in the rear part. The arrangement shown additionally further comprises an insulation 32.

The operation of the tripping mechanism shown in FIG. 5 is similar to the mode of operation of the arrangement shown in FIGS. 3 and 4. In this case too, the tripping of the circuit breaker is dependent both on the temperature of the bimetal element 4 and on the present current through the coil 3. Again, the temperature of the bimetal element 4 is in effect an integral of the current through the coil 3 with respect to time, meaning that the effect of the bimetal element 4 is predominant at currents which are above an admissible value for a long duration but only by a slight amount. However, if the current rises very rapidly a long way above an admissible value, the effect of the electromagnetic force on the armature/plunger 25 is predominant, and pulls it in the direction of the yoke 5 or in the direction of the lever system 13.

FIG. 6 is a detailed plan view of the leaf springs 26 and FIG. 7 is a detailed plan view of the bimetal element 4. The recesses by means of which the two parts hook into one another can clearly be seen. The forked projections of the leaf spring 26 engage in the grooves in the bimetal element 4, resulting in a type of articulated connection. The leaf spring 26 is mounted in the yoke 5 in a similar manner in the lower region. For the same purpose, it is naturally also conceivable for the bimetal element 4 to have forked ends in which a groove in the leaf spring 26 engages. Naturally, the arrangement shown is not only applicable to the tripping mechanism shown in FIG. 5, but can also be used in the tripping mechanism shown in FIGS. 3 and 4.

Generally, the arrangement shown in FIG. 5 further has the following features. In this example, the leaf spring 26 again acts on the end of the armature/plunger 25 facing away from the switching contact 1 or lever system 13. As a result, the interface between the armature/plunger 25 and the switching contact 1 or lever system 13 can be kept simple and can also be used for existing systems.

In this example, the leaf spring 26 is further connected/hooked to the armature/plunger 25. As a result, both tensile and compressive forces can be transmitted between the leaf spring 26 and the armature/plunger 25.

In the variant configuration shown in FIG. 5, the bimetal element 4 further curves towards the electromagnetic tripping device 2 during heating. In combination with a leaf spring 26, this results in an increasing progression of the force acting on the plunger 25. Likewise, in this context there is a decreasing progression of the distance covered by the plunger 25 with respect to the distance covered by the free end (or the end acting on the leaf spring 26) of the bimetal element 4.

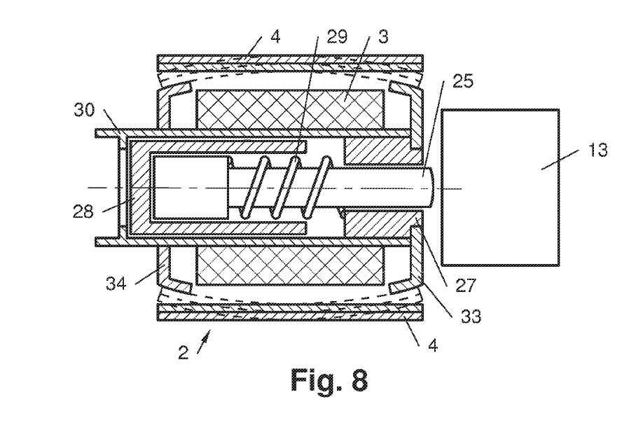

FIG. 8 now shows a further example of a tripping mechanism, in which the bimetal element 4 acts indirectly on a switching contact or on a lever system (only shown symbolically in this case) connected to the switching contact via the electromagnetic tripping device 2. Unlike in the variants shown previously, however, two bimetal elements 4 are now inserted into the iron circuit or magnetic yoke 5 of the electromagnetic tripping device 2 in such a way that a magnetic flux through the iron circuit/magnetic yoke in a first position (shown in solid lines) of the at least one bimetal element 4 at a first temperature is less than the magnetic flux through the iron circuit/magnetic yoke in a second position (shown in dashed lines) of the at least one bimetal element 4 at a second temperature.

Specifically, as well as a coil 3 and a centrally arranged sleeve 30 preferably made of plastics material, the electromagnetic tripping device 2 comprises two sleeves 27 and 28, a front plate 33 and a rear plate 24, which form parts of the iron circuit/magnetic yoke. In addition, the bimetal elements 4 also form parts of the iron circuit/magnetic yoke.

In the present example, exactly two bimetal elements 4 are inserted into the iron circuit/magnetic yoke. However, it would also be conceivable for merely one bimetal element 4 or even more bimetal elements 4 to be inserted into the iron circuit/magnetic yoke. In this example, the bimetal elements 4 are arranged parallel to a movement direction of the plunger 15 of the electromagnetic tripping device 2. This results in a particularly compact construction of the circuit breaker. The operation of the tripping mechanism shown in FIG. 8 is now as follows.

In this example, in a rest state, the bimetal elements are more or less straight, resulting in gaps in the iron circuit/magnetic yoke that are adjacent to the bimetal elements 4. As the heating increases, the bimetal elements 4 curve towards the coil 3, causing the gaps to become smaller. The electromagnetic tripping device 2 shown thus has gaps in the iron circuit/magnetic yoke that are variable as a function of the temperature of the bimetal element 4. From a particular temperature, the bimetal elements 4 are so heavily curved that the gaps are closed.

Advantageously, in this way the magnetic flux in the iron circuit or magnetic yoke and thus the generated electromagnetic force on a plunger 25 of the electromagnetic tripping device 2 can be influenced. The bimetal element 4 thus takes effect on the switching contact or the lever system 13 cooperating therewith indirectly via the electromagnetic tripping device 2. This arrangement has the advantage that the force that the bimetal element 4 has to apply is very small, since it basically works as a switch. The bimetal element 4 can therefore be kept very small.

In the present example, exactly two gaps per bimetal element 4 are provided in the iron circuit/magnetic yoke and are variable as a function of the temperature of said bimetal element 4. However, it would also be conceivable for exactly one gap in the iron circuit/magnetic yoke per bimetal element 4 to be variable as a function of the temperature of said bimetal element 4. For example, each end of each bimetal element 4 could be fixedly connected to the plate 33 or the plate 34.

As a result of a current through the coil 3, an electromagnetic force on the sleeve 28 and thus on the plunger 25 is generated, and pulls it in the direction of the lever system 13 counter to the force of the compression spring 29. As a result of the gap becoming narrower and narrower, the electromagnetic force likewise becomes greater and greater. However, the magnetic flux and thus the electromagnetic force are also affected by the gaps adjacent to the bimetal elements 4. The magnetic flux and thus the electromagnetic force are also greater for smaller gaps, and accordingly smaller for larger gaps. Therefore, the temperature of the bimetal elements 4 has an effect on the force acting on the armature/plunger 25.

In the tripping mechanism shown in FIG. 8, too, the tripping of the circuit breaker is thus dependent both on the temperature of the bimetal element 4 and on the present current through the coil 3. The temperature of the bimetal element 4 is again an integral of the current through the coil 3 with respect to time, meaning that the effect of the bimetal element 4 is predominant at currents which are above an admissible value for a long duration but only by a slight amount. However, if the current rises very rapidly a long way above an admissible value, the effect of the electromagnetic force on the armature/plunger 25 is predominant, and pulls it in the direction of the yoke 5 or in the direction of the lever system 13.

Preferably, the first temperature, associated with a larger gap, is less than the second temperature, associated with a smaller gap. As a result, the magnetic flux and thus the force acting on the plunger 4 of the electromagnetic tripping device 2 are larger at the higher temperature. An increase in current therefore always brings about an increase in said force, regardless of whether this takes place by way of the current through the coil 3 of the electromagnetic tripping device 2 or by way of the bimetal element 4 changing from the first to the second position as a result of the increased current.

Generally, tripping mechanisms in which the bimetal element 4 acts on a switching contact, or on a lever system 13 connected to the switching contact, of the circuit breaker indirectly via the electromagnetic tripping device 2 (see in particular FIGS. 3 to 8) are particularly suitable for use in existing systems. The lever system 13 does not actually need to be changed for this purpose, since the bimetal element 4 acts on the lever system 13 indirectly via the plunger 4, as indicated above. The use of a tripping mechanism of this type does not alter anything as regards the lever system 13.

It is further noted that the tripping mechanisms shown in FIGS. 1 and 2 are also applicable analogously to the tripping mechanisms shown in FIGS. 3 to 8. For example, the bimetal element 4 may be arranged at a distance from the electromagnetic tripping device 2. The bimetal element 4 and the electromagnetic tripping device 2 may also be arranged directly adjacent in the circuit breaker. In addition, it is conceivable for the bimetal element 4 to be provided, at least in the region of the thermal coupling to the electromagnetic tripping device 2, and/or for the electromagnetic tripping device 2 to be provided, at least in the region of the thermal coupling to the bimetal element 4, with a coating that absorbs at least 90% of the infrared radiation. It is also possible for the bimetal element 4 to be arranged above the electromagnetic tripping device 2 or for a conduction device for conducting hot air from the electromagnetic tripping device 2 to the bimetal element 4 to be provided. In the variants shown in FIGS. 3 to 5, it is additionally conceivable for the bimetal element 4 to form part of the yoke 5 of the electromagnetic tripping device 2. Finally, using the embodiments shown in FIGS. 3 to 8, it is also possible to form a production series of a plurality of circuit breakers in which the coils 3 are made of wire of different thickness and are of substantially the same diameter, in particular external diameter (compare FIGS. 1 and 2 on this point). In particular, the distance between the bimetal element 4 and the electromagnetic tripping device 2 may be substantially the same in a plurality of circuit breakers.

Finally, it is noted that the tripping device is not necessarily shown to scale and may therefore have different proportions. Further, the tripping device may also comprise more or fewer components than shown. Positional indications (for example “up”, “down”, “left”, right” etc.) are in relation to the drawing being described in each case, and should be adapted analogously to the new position in the event of a change in position. For example, the electromagnetic tripping device 2 and the bimetal element 4 may also be oriented vertically instead of horizontally as shown. Finally, it is noted that the above embodiments and developments of the invention may be combined in any desired manner.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise. Moreover, the recitation of “A, B, and/or C” or “at least one of A, B, or C” should be interpreted as including any singular entity from the listed elements, e.g., A, any subset from the listed elements, e.g., A and B, or the entire list of elements A, B, and C.

1. A circuit breaker, comprising:
a first terminal contact and a second terminal contact. the first and second terminal contacts being electrically connected within the circuit breaker via a switching contact;
an electromagnetic tripping device configured to act on the switching contact or on a lever system connected to the switching contact, a coil of the electromagnetic tripping device being connected between the first and second terminal contacts;
a bimetal element configured to act on the switching contact or on the lever system,
wherein an electrical connection between the first and second terminal contacts bypasses the bimetal element,
wherein the bimetal element thermally coupled to the electromagnetic tripping device,
wherein the bimetal element is configured to act on the switching contact indirectly via an iron circuit or magnetic yoke of the electromagnetic tripping device, and
wherein the bimetal element is inserted into the iron circuit or magnetic yoke of the electromagnetic tripping device such that a magnetic flux through the iron circuit/magnetic yoke in a first position of the bimetal element at a first temperature is less than the magnetic flux through the iron circuit/magnetic yoke in a second position of the bimetal element at a second temperature.

2. The circuit breaker of claim 1, wherein the first temperature is less than the second temperature.

3. The circuit breaker of claim 1, comprising a gap in the iron circuit/magnetic yoke,
wherein the gap is variable as a function of the temperature of the bimetal element.

4. The circuit breaker of claim 3, comprising exactly one gap in the iron circuit/magnetic yoke per bimetal element which is variable as a function of the temperature of the bimetal element.

5. The circuit breaker of claim 3, comprising exactly two gaps in the iron circuit/magnetic yoke per bimetal element which are variable as a function of the temperature of the bimetal element.

6. The circuit breaker of claim 3, comprising a gap that is present at the first temperature is closed at the second temperature.

7. The circuit breaker of claim 1, comprising exactly one bimetal element, inserted into the iron circuit/magnetic yoke.

8. The circuit breaker of claim 1, comprising exactly two bimetal elements, inserted into the iron circuit/magnetic yoke.

9. The circuit breaker of claim 1, wherein the bimetal element is arranged parallel to a movement direction of a plunger of the electromagnetic tripping device.
